(19) United States
(12) Patent Application Publication
(10) Pub. No.: US 2026/0149671 A1
(43) Pub. Date: May 28, 2026

(54) FAST CONVERGENCE DURING AN INCAST EVENT

(71) Applicant: Advanced Micro Devices, Inc., Santa Clara, CA (US)

(72) Inventors: Rong PAN, Santa Clara, CA (US); Yanfang LE, Santa Clara, CA (US); Peter NEWMAN, Santa Clara, CA (US); Vipin JAIN, Santa Clara, CA (US); Jeremias BLENDIN, Bellevue, WA (US)

(21) Appl. No.: 18/957,503

(22) Filed: Nov. 22, 2024

(51) Int. Cl. H04L 47/32; H04L 47/283

(52) U.S. Cl. CPC H04L 47/323; H04L 47/283

(57) ABSTRACT

Embodiments herein describe throttling traffic using an achieved bandwidth delay product (BDP). As a sending device receives acknowledgments (ACKs) from a receiving device, the sending device determines whether the ACKs are marked to indicate the corresponding packet experienced congestion in the network. In addition, the sending device determines a delay associated with the packet being transmitted from the sending device to the receiving device. If this delay is much greater than a target delay threshold and the ACK indicates there was, then a transmission limit (e.g., a congestion control window size or a transmission control rate) is set based on an achieved BDP.

### TECHNICAL FIELD

The embodiments presented herein relate to congestion management, and in particular to fast convergence to an achieved bandwidth delay product (BDP).

### BACKGROUND

Devices in data centers are connected through Ethernet based high speed networking devices such as network interfaces, switches, and routers. These networking devices often employ congestion management mechanisms, such as congestion control and load balancing, to enhance network performance. While existing methods of congestion management, such Data Center Quantized Congestion Notification (DCQCN), aim to alleviate congestion levels and avoid congestion spreading, they may struggle in large-scale environments, leading to slow network performance and excessive traffic delays. As data center applications, such as emerging artificial intelligence (AI) and machine learning (ML) training networks, continue to demand higher utilization of their network links, bandwidth utilization optimization in the context of congestion management has become a key consideration.

For networking, an incast event happens when multiple senders send traffic to a single receiver; and cause high degree of congestion either at the destination Top of Rack (TOR) switch or at the receiver network interface card/controller (NIC). Current algorithms like TIMELY, SWIFT and DCQCN take multiple Round Trip Time (RTTs) to converge to the right rate/window.

### SUMMARY

One embodiment described herein is a method that includes transmitting a packet from a sending device to a receiving device, determining a delay based on receiving an acknowledgement (ACK) from the receiving device, and, determining a delay based on receiving an acknowledgement (ACK) from the receiving device; and upon determining (i) the ACK indicates congestion in a receive (RX) queue when the packet was transmitted from the sending device to the receiving device and (ii) the delay satisfies a second delay threshold that is greater than a target delay threshold, setting a transmission limit used to transmit packets to the receiving device based on an achieved bandwidth delay product (BDP).

Another embodiment described herein is a sending device that includes circuitry configured to transmit a packet to a receiving device, determine a delay based on receiving an ACK from the receiving device, and, upon determining (i) the ACK indicates congestion in a RX queue when the packet was transmitted from the sending device to the receiving device and (ii) the delay satisfies a second delay threshold that is greater than a target delay threshold, set a transmission limit used to transmit packets to the receiving device based on an achieved BDP.

Another embodiment described herein is a network interface card/controller (NIC) that includes circuitry configured to transmitting a packet from a sending device to a receiving device, determining a delay based on receiving an acknowledgement (ACK) from the receiving device, and, determining a delay based on receiving an acknowledgement (ACK) from the receiving device; and upon determining (i) the ACK indicates congestion in a receive (RX) queue when the packet was transmitted from the sending device to the receiving device and (ii) the delay satisfies a second delay threshold that is greater than a target delay threshold, setting a transmission limit used to transmit packets to the receiving device based on an achieved BDP.

### BRIEF DESCRIPTION OF DRAWINGS

FIG. 1A illustrates a network, according to one embodiment herein.

FIG. 2 illustrates a queue of a receiving network device, according to one embodiment herein.

FIG. 3 is flowchart for adjusting a transmission limit of a sending network device using achieved BDP, according to one embodiment herein.

FIG. 4 is flowchart for determining when to trigger fast convergence, according to one embodiment herein.

FIG. 5 is a flowchart for averaging acknowledged bytes, according to one embodiment herein.

FIG. 6 illustrates a data processing unit, according to one embodiment herein.

### DETAILED DESCRIPTION

During an incast, the number of acknowledged (acked) bytes that are sent back to each of the senders is limited by the receiver's link speed and processing capacity. Hence, the acked bytes sent back to a sender over one RTT (or an average over multiple RTTs) is a strong indication of the congestion level at the receiver, which the embodiments herein use to quickly converge to a suitable rate.

In one embodiment, as a sender receives acknowledgments (ACKs) from a receiver, the sender determines whether the ACKs are marked to indicate whether the corresponding packet experienced congestion in the network. This congestion could be detected using explicit congestion notification (ECN), in-network telemetry, and the like. In addition, the sender determines a delay associated with the packet being transmitted from the sender to the receiver which could be a round trip time (RTT) delay, or the one-way delay from the sender to the receiver. If (i) this delay is much greater than a threshold (e.g., more than 1.5 times, or more than 2 times, the target delay), (ii) the average delay is greater than the target delay, and (iii) the ACK indicates there was congestion in the network (e.g., the packet was ECN marked), then a transmission limit (e.g., a congestion control window size or a transmission control rate) is set to an achieved BDP. In one embodiment, the achieved BDP is the number of acked bytes that are received during a defined period of time (e.g., a baseline RTT), or the average number of acked bytes received over multiple time periods.

In this manner, fast convergence is achieved within one RTT. While further adjustments can be made (e.g., using conventional techniques), performing the embodiments herein can quickly adjust the transmission limits for senders so they are much closer to an optimal transmission rate than current techniques. Advantageously, this reduces the likelihood of dropped packets, enables a receiver to recover much faster from congestion, saves power, among other advantages.

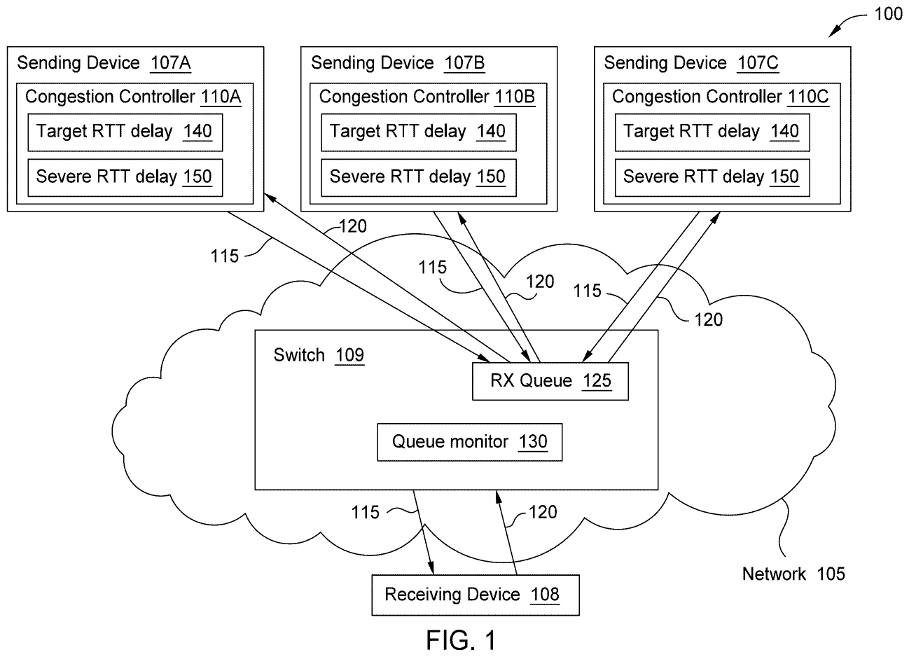

FIG. 1A illustrates a system 100 that includes a network 105, according to one embodiment herein. The system 100 includes multiple sending devices (i.e., sending devices 107A-C) transmitting data to a receiving device 108 via the network 105. The sending devices 107A-C can also be referred to senders/transmitters while the receiving device 108 can be referred to as receiver. In one embodiment, the sending devices 107A-C and the receiving device 108 are hosts that are communicatively coupled by network devices in the network 105 (which can include any number of routers, switches, etc.). The sending devices 107A-C and the receiving device 108 can include any number of processors (e.g., central processing units (CPUs), graphical processing units (GPUs), accelerators, and the like), memory (e.g., volatile and/or non-volatile memory devices), and network interface controllers/cards (NICs). For example, the NICs in the sending devices 107A-C and the receiving device 108 can transmit the data as shown in FIG. 1A.

In this scenario, the sending devices 107A-C transmit one or more packets 115 to the receiving device 108 using the network 105. When received at the receiving device 108, it transmits corresponding ACKs 120 back to the respective sending devices 107A-C. The ACKs 120 let the sending devices 107A-C know the packets 115 were successfully received at the receiving device 108.

In addition, the sending devices 107A-C can use the ACKs 120 to determine a delay corresponding to the packets 115. This delay is determined by congestion controllers 110 in the sending devices 107A-C, which can be software applications (which are stored in memory and executed by one or more processors in the sending devices 107A-C) or specialized hardware. In any case, the sending devices 107A-C can include circuitry (such as processors or specialized hardware) for performing the functions described herein.

In one embodiment, the congestion controllers 110 use timestamps when the ACKs 120 were received at the sending devices 107A-C to determine a RTT for the packets 115 and the ACKs 120. That is, the congestion controllers 110 can record timestamps when the packets 115 were transmitted and timestamps with the ACKs 120 were received. Finding the difference between the sending and receiving timestamps provides the RTT.

The congestion controllers 110 can then determine a delay corresponding to the transmit and receive paths between the sending devices 107A-C and the receiving device 108. In one embodiment, the delay is based on an actual delay experienced by a packet from the sending devices 107A-C subtracted by a baseline propagation delay, where the baseline propagation delay is based on the specific path and the number of switches the packet travels through in the network 105 when there is no network congestion (or when the network 105 is an uncongested network). In one embodiment, the measured delay can be obtained by subtracting an actual RTT of a packet by a baseline RTT. As discussed above, RTT is the latency that a packet experienced going through a network. In some examples, an actual RTT can be based on the difference between a packet transmit time from a sender and an ACK receipt time at the sender. In some examples, a baseline RTT can represent a lowest RTT value in an uncongested network (e.g., when there is no network congestion). The baseline RTT can be determined by the sending devices 107A-C.

However, in another embodiment, the ACKs 120 can include within them a one-way delay between the sending devices 107A-C and the receiving device 108. For example, the network 105 may be a synchronized network where the clocks in the sending devices 107A-C and the receiving device 108 are synchronized. When sending the packets 115, the sending devices 107A-C can put a timestamp in the packets 115. The receiving device 108 can subtract that timestamp with a current timestamp (e.g., the current value of its internal clock) to determine the one-way delay. Because the clocks are synchronized, the system 100 can be confident that this delay is accurate. The receiving device 108 can then embed the one-way delay in the ACK 120, thereby informing the congestion controllers 110 in the sending devices 107A-C of the delay.

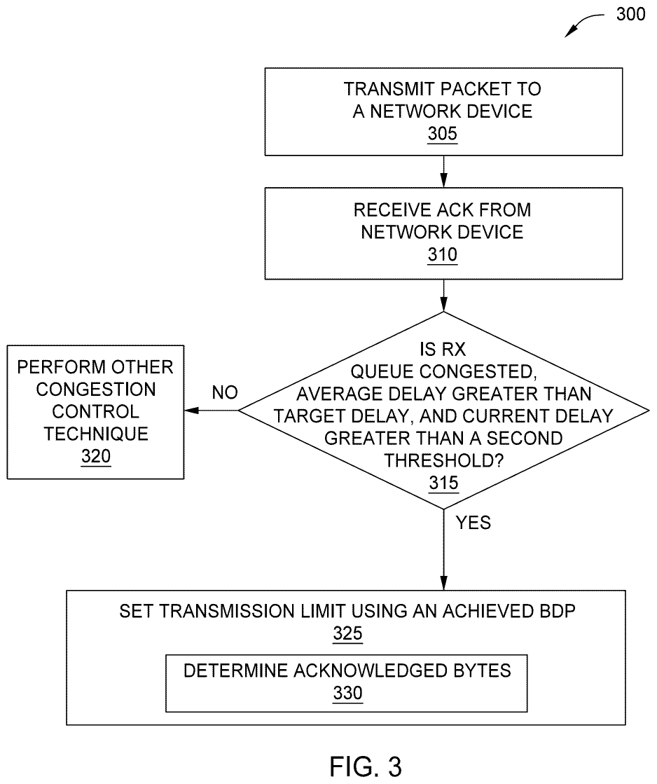

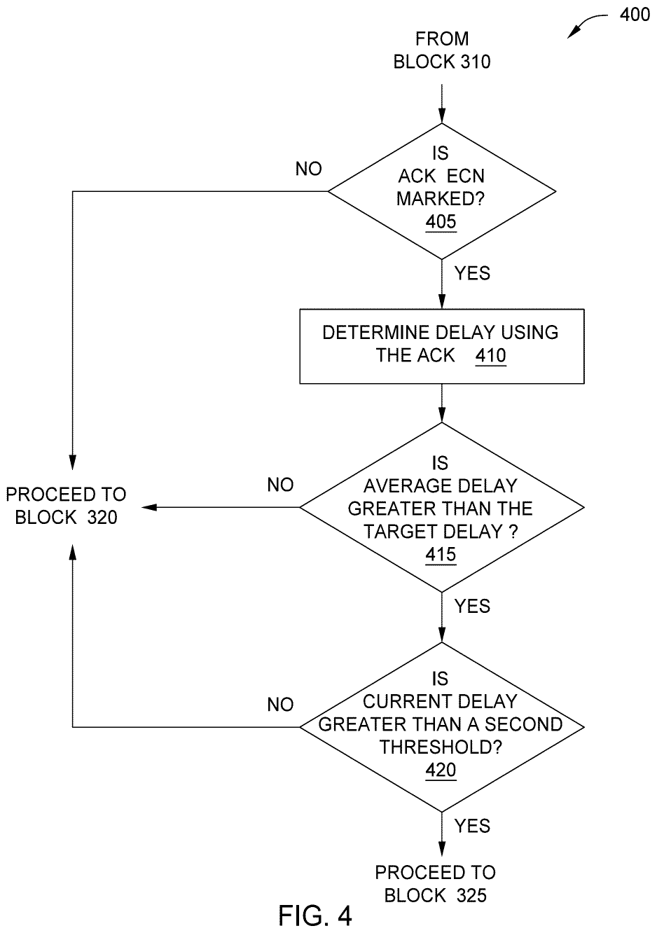

Regardless if the delay is a RTT delay or a one-way delay, the congestion controller 110 can use the delay to determine whether there is congestion in the network (e.g., at a switch 109). If congestion is detected, the congestion controller 110 can determine how to throttle data being sent to the receiving device 108. This can include using one congestion control algorithm or using multiple congestion control algorithms. This is discussed in more detail in FIGS. 3-4.

The switch 109 includes a receive (RX) queue 125 for buffering the packets received form the sending devices 107A-C. The RX queue 125 gives the switch 109 a buffer if the sending devices 107A-C transmit more packets than the switch 109 can process (e.g., when the receive rate is greater than the forwarding rate of the switch 109). An incast event happens when multiple senders send traffic to a single receiver and cause high degree of congestion where the queue 125 is filling up. If the amount of data being transmitted by the sending devices 107A-C to the switch 109 (e.g., a TOR switch) is not throttled, the switch 109 may be forced to drop packets.

To mitigate an incast event, the switch 109 includes a queue monitor 130 that monitors the occupancy of the RX queue 125 (or how full it is). The queue monitor 130 can perform different actions depending on how full the queue 125 is. Of note here, the queue monitor 130 can mark the packets 115 to indicate there is congestion at the RX queue 125. This could be done using ECN or in-network telemetry where bits are added to the headers of the forwarded packets 115.

In one embodiment, the queue monitor 130 determines whether to mark a packet 115 when a packet 115 leaves the queue 125 and is forwarded to the receiving device 108, instead of when a packet 115 is first stored in the queue 125. That is, when the switch 109 removes a packet 115 from the RX queue 125 (which may be a FIFO), the queue monitor 130 checks to see if the queue 125 is currently congested. If so, the forwarded packet 115 is marked using ECN or in-network telemetry.

Evaluating whether the queue is congested when a packet is leaving the queue (rather than when the packet enters the queue) advantageously provides an earlier warning of congestion at the switch 109. For example, when a packet arrives at the RX queue 125, the queue 125 may not be congested. However, a large batch of packets 115 may soon arrive so that when the switch 109 pulls out a packet 115 to forward the packet 115 to the receiving device 108 (or to another switch on the path to the receiving device 108), the queue 125 is now congested. The switch 109 edits the header of that packet 115 to indicate to the receiving device 108 that the Rx queue 125 is congested. This technique looks back into the queue 125 to determine congestion.

In contrast, if the queue monitor 130 determines queue congestion when the packet 115 arrives, the system 100 would have to wait until the marked packet 115 finally makes it through a congested RX queue 125 before the receiving device 108 is alerted to congested at the switch 109. Thus, the receiving device 108 would have to wait for the entire queue delay before being informed of congestion at the RX queue 125 in the switch 109. In contrast, by looking back, the queue monitor 130 can provide an indication to the receiving device 108 of congestion at the RX queue 125 in forwarded packets 115 that may have arrived at the switch 109 before there was congestion at the RX queue 125.

The queue monitor 130 can be a software application (which is stored in memory and executed by one or more processors in the switch 109) or specialized hardware. In any case, the switch 109 can include circuitry (such as processors or specialized hardware) for performing the functions described herein.

The receiving device 108 receives the packets 115 and can check if they include data indicating there was congestion in a switch in the network 105 (e.g., switch 109). For example, the packets 115 can be ECN marked or include in-network telemetry that informs the receiving device of congestion in the network 105. In turn, the receiving device 108 can mark the ACKs 120 being sent back to the sending devices 107 to inform the sending devices of congestion in the forward path from the sending devices 107 to the receiving device 108. Moreover, while the embodiments herein describe detecting congestion in the network 105, the receiving device 108 may detect congestion in its own RX queue, even if there is no congestion in the network 105 (e.g., none of the received packets 115 are ECN marked).

In one embodiment, the congestion controllers 110 average the delay measured to avoid outliners and ensure that it is an incast event. As packets may traverse different paths to reach the receiver, if there is no incast, some packets may incur high delay and some may not. However, in an incast event, generally every packet that reaches the destination would incur high delay, and hence the average delay would be high. In one embodiment, as new ACKs are received, the average delay can be updated using the following equation:

$$Average\_delay = {( 1 - w )}^{⋆} Average\_delay + {w}^{⋆} Delay \qquad ( 1 )$$

In Equation 1, w is an averaging parameter and the Delay is the measured delay of a particular packet. This measured delay is scaled by the averaging parameter w and then added to the previously calculated average delay (which is in turn scaled by 1−w).

As discussed in more detail below, the congestion controllers 110 can use the current measured delay, the average delay, and the indications of congestion in the RX queue 125 in the ACKs 120 to determine when to reduce a transmission limit that controls how much data the sending devices 107A-C send to the receiving device 108. As part of this, the congestion controllers 110 can use two thresholds: a target RTT delay 140 and a severe RTT delay 150. Different congestion algorithms can be performed using these two delays as discussed in FIG. 3 below.

In one embodiment, the congestion controllers 110 also use the ACKs 120 to determine the amount of data (e.g., the number of bytes) the receiving device 108 received from each of the sending devices 107A-C during a particular time period, which is referred to as the achieved BDP. If there is substantial congestion (as determined using the RTT or one-way delay and queue congestion), the congestion controllers 110 can reduce the transmission limit to the achieved BDP from previous time periods so the sending devices 107A-C only transmit that amount of data to the receiving device 108 in the next time period.

In one embodiment, the congestion controllers 110A-C for each of the sending devices 107A-C can perform this congestion control algorithm independently of each other. In other words, each congestion controller 110 can determine its achieved BDP and throttle its data accordingly when detecting substantial congestion, regardless how the other congestion controllers 110 throttle the data they are sending to the receiving device 108. Once throttled, the congestion controllers 110 may switch to other congestion control algorithms which may consider the amount of data each sending devices 107A-C transmits to the receiving device 108, which can introduce the idea of fairness.

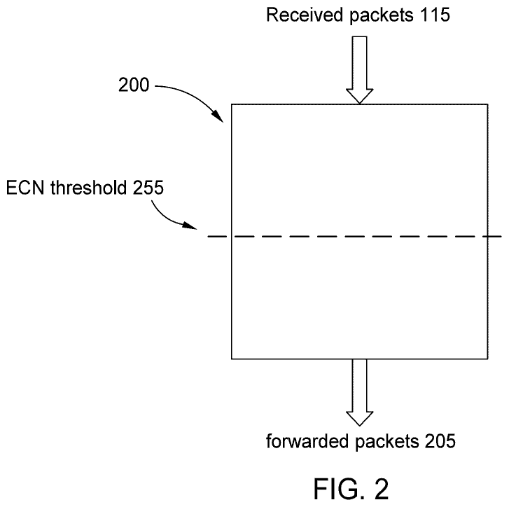

FIG. 2 illustrates a queue 200 of a receiving network device, according to one embodiment herein. For example, the queue 200 can be one implementation of the RX queue 125 in FIG. 1A.

It assumed that the queue 200 is filled from the bottom up. When the usage of the queue 200 is below the ECN threshold 255, no ECN is performed by the queue monitor. That is, when a forwarded packet 205 is pulled from the queue and there are only packets stored in the region below the ECN threshold 255, then the queue monitor does not mark the forwarded packet 205 to indicate the queue 200 is congested.

However, when the usage of the queue 200 is above the ECN threshold 255, ECN is performed by the queue monitor. That is, when a forwarded packet 205 is pulled from the queue and there are packets below and above the ECN threshold 255, then the queue monitor marks the forwarded packet 205 to indicate the queue 200 is congested.

In one embodiment, an ECN marking is a binary marking (e.g., a first value to indicate no congestion (e.g., the utilization of the queue 200 is below the ECN threshold 255) or a second value to indicate there is congestion (e.g., the utilization of the queue 200 is at or above the ECN threshold 255). However, in other embodiments, the congestion marking in the forwarded packets 205 (whether ECN or in-network telemetry) can indicate a degree or amount of congestion in the queue 200 (e.g., there could be multiple ECN thresholds). In any case, the markings in the forwarded packets 205 provide the receiving device (and eventually the sending devices) the state of the queue 200 when a forwarded packet 205 is leaving the queue 200, rather than the state of the queue 200 when a received packet 115 enters the queue 200.

FIG. 3 is flowchart of a method 300 for adjusting a transmission limit of a sending network device using achieved BDP, according to one embodiment herein. At block 305, a sending device (e.g., a host) transmits a packet to a receiving device (e.g., another host).

At block 310, the sending device receives an ACK from the receiving network device, indicating the receiving device successfully received the packet. In addition to performing this function, the ACK can also include an indication if a RX queue in the forward path (i.e., the path from the sending device to the receiving path) was congested. This could be a RX queue in a network device (e.g., a switch) in the network that connects the sending and receiving devices, or could be congestion in the RX queue of the receiving device.

As discussed above, the congestion could be recorded in the forward path using ECN markings or in-network telemetry. In any case, when the receiving device detects congestion in the forward path, and can mark the ACKs accordingly so that the sending devices are aware of the congestion.

In addition to including a marking for congestion, the ACK can be used by the sending device to determine a delay in the network. This is discussed more at block 315.

At block 315, the sending network device determines whether the RX queue of the receiving network device is congested and whether the delay is much larger than a target delay. To determine whether the RX queue is congested, the congestion controller in the sending network device can determine whether the ACK indicates to a packet in the forward path was ECN marked or including in-network telemetry that indicates a RX queue was congested when the packet exited the queue.

To determine the delay, in one embodiment, the congestion controller in the sending device determines a RTT delay between the sending device and the receiving device. To do so, the congestion controller can compare a timestamp captured by the sending device when it transmitted the packet to a timestamp captured by the sending device when it received the corresponding ACK. This provides the RTT. In one embodiment, the delay is then be obtained by subtracting the measured RTT by a baseline RTT. As discussed above, RTT is the latency that a packet experienced going through a network. In some examples, an actual RTT can be based on the difference between a packet transmit time from a sender and an ACK receipt time at the sender. In some examples, the baseline RTT can represent a lowest RTT value in an uncongested network (e.g., when there is no network congestion).

However, instead of using RTT delay, in another embodiment the congestion controller can identify a one-way delay. As discussed above, the clocks on the sending and receiving devices can be synchronized. The receiving network device can calculate the one way delay by subtracting a timestamp in the received packet from a timestamp when the packet was received at the receiving device, and put this one-way delay in the ACK to inform the sending device.

Alternatively, when sending the ACK, the receiving device can put a timestamp in the ACK indicating when the packet was received at the receiving device. The congestion controller in the sending device can compare the timestamp when it transmitted the packet to the timestamp when the receiving device received the packet to identify the one-way trip time. This one-way trip time can be subtracted from a baseline trip time (e.g., when there is no network congestion) to identify the one-way delay.

Regardless whether the delay is a RTT delay or a one-way delay, the congestion controller in the sending network device determines whether the average delay is much larger than a target delay (e.g., a target RTT delay 140 in FIG. 1A or a target one-way delay), and whether the current delay measurement is higher than a second high-mark threshold (e.g., the severe RTT delay 150 in FIG. 1A). The reason for checking two threshold is because packets might take different routes (or paths) towards the receiving device. Comparing the delay to two thresholds ensures that not only are these paths indeed large (i.e., the delay is larger than the high-mark threshold) and all the paths are congested (i.e., the average delay is larger than the target delay), which usually indicates an incast scenario as there is only a single path (where all the different routes/paths meet) towards the destination and it is congested.

In one embodiment, the target delay (e.g., the target RTT delay 140) is approximately one-half of a base RTT. The second high-mark threshold (e.g., the severe RTT delay 150) can be two or three times the base RTT delay. In one embodiment, the base RTT is the time difference between sending a packet and receiving its ACK back under no network congestion. In this case, the base RTT delay is the propagation delay plus the packet processing delay, with no network congestion.

If either the RX queue is not congested (e.g., the ACK is not ECN marked) or the average delay is not much greater than the target delay (e.g., the delay does not exceed or satisfy the severe RTT delay 150) or the current delay is not larger than the second high-mark threshold, the method 300 process to block 320 where the sending network device performs a different congestion control technique. These could include TIMELY, SWIFT, DCQCN, etc.

However, if the congestion controller determines the RX queue for the receiving network device is congested and the delay between the two network devices is larger than the second high-mark threshold (e.g., satisfies the severe target delay), the method 300 instead proceeds to block 325 where the congestion controller sets a transmission limit using an achieved BDP.

In one embodiment, a transmission limit (e.g., a congestion control window size or a transmission control rate) is set to the achieved BDP. In one embodiment, the achieved BDP is the number of acked bytes that are received during a defined period of time (e.g., a base RTT), or the average number of acked bytes received over multiple time periods. As such, block 325 has a sub-block 330 where the congestion controller determines the acked byes received over a set time period (e.g., base RTT, assuming RTT delay is being measured). In this scenario, the congestion controller tracks the size or amount of data in the packets the sending device transmits to the receiving device. As the corresponding ACKs are received, the congestion controller can identify the amount of data in the corresponding packets and add their data amounts to determine the achieved BDP.

For example, in one time period, the sending network device may receive five ACKs that correspond to five packets that are each 100 kilobytes (KB) of data, for a total of 500 KB during that time period. During a second time period, the sending device may receive three ACKs that correspond to three packets that are each 200 kB of data, for a total of 600 kB during that time period. Thus, while two fewer ACKs are received during the second time period, the achieved BDP is higher for the second time period because more data was successfully received and processed at the receiving device than the first time period.

At block 325, the congestion controller sets the transmission limit for the next time period to be the achieved BDP of the previous time period (or an average of multiple previous time periods). For instance, if the achieved BDP for the previous time period when the conditions at block 315 were both true was 500 KB, then in the next time period the congestion controller transmits packets that at most contain a total of 500 KB to the receiving device.

Notably, the method 300 can be performed in an incast event where multiple sending devices transmit data to the same receiving device. The conditions at block 315 may be true for all the sending devices, or only a subset of these devices. Further, the achieved BDP can be independently measured by each of the sending devices. For example, one sending device may be lucky and have more of its packet data processed by the receiving device than the other sending devices, in which case its achieved BDP may be much larger than the other sending devices in the next time period. For example, a first sending device may have 500 KB of its packet data acknowledged by the receiving device while a second sending device may have only 200 kB of its packet data acknowledged by the receiving device over the same time period. This result may not be fair, but the method 300 gets the sending devices to the optimal BDP much faster than other congestion control algorithms by avoiding multiple RTT evaluations. Other congestion control techniques (such as the ones performed at block 320) can be used to establish fairness after the severe congestion has abated (e.g., when one of the conditions in 315 is no longer true).

FIG. 4 is flowchart of a method 400 for determining when to trigger fast convergence, according to one embodiment herein. The method 400 is one implementation of block 315 in FIG. 3 to detect severe congestion at the receiving network device. As such, the method 400 begins after block 310 of method 300.

At block 405, the congestion controller in the sending network device receives an ACK and determines whether the ACK is marked to indicate there was congestion at a RX queue in the forward path (e.g., a packet was ECN marked). Of course, ECN is just one example of marking packets to indicate congestion in the forward path, and in other embodiments, in-network telemetry can be used.

If the ACK is not marked to indicate there was congestion (e.g., the corresponding packet was not ECN marked when received at the receiving device), the method 400 proceeds to block 320 to perform some other congestion algorithm.

However, if the ACK is marked to indicate the corresponding packet experienced congestion in an RX queue, the method 400 proceeds to block 410 where the congestion controller determines a delay between the sending and receiving network devices using the ACK. As discussed above, the sending device can determine a RTT by comparing a timestamp when the ACK was received to a timestamp when the sending device sent the corresponding packet. This RTT can be subtracted from a baseline RTT to generate a RTT delay.

In another embodiment, the ACK includes a one-way delay which was calculated by the receiving device. As discussed above, the clocks of the sending and receiving devices can be synchronized. This enables the receiving device to determine the one-way delay using a timestamp in the received packet, or to transmit its timestamp to the sending device which can determine the one-way delay.

At block 415, the congestion controller at the sending device determines whether the average delay is greater than the target delay (e.g., the target RTT delay 140 in FIG. 1A, which may have a value of one half the base RTT). If not, the method 400 proceeds to block 320 to perform a different congestion control algorithm.

As mentioned above, the congestion controller can average the delay for multiple packets received over a time period. In an incast event, generally every packet that reaches the destination would incur high delay, and hence the average delay would be greater than the target delay.

If the average delay is above the target delay, the method 400 proceeds to block 420 where the congestion controller determines if the current delay is greater than (or satisfies) a second threshold that is greater than the target delay (e.g., the severe RTT delay 150 in FIG. 1A, which may have a value of two or three times the base RTT). The current delay can be measured by measuring the RTT of the packet. If not, the method 400 proceeds to block 320 to perform a different congestion control algorithm. Note, the congestion algorithm performed at block 320 may be different when the delay is less than the target delay (as determined at block 415) or when the delay is greater than the target delay but less than the second delay (as determined at block 420.

If the delay is above the second threshold, the method 400 proceeds to block 325 where a transmission limit is set to the achieved BDP as discussed in FIG. 3.

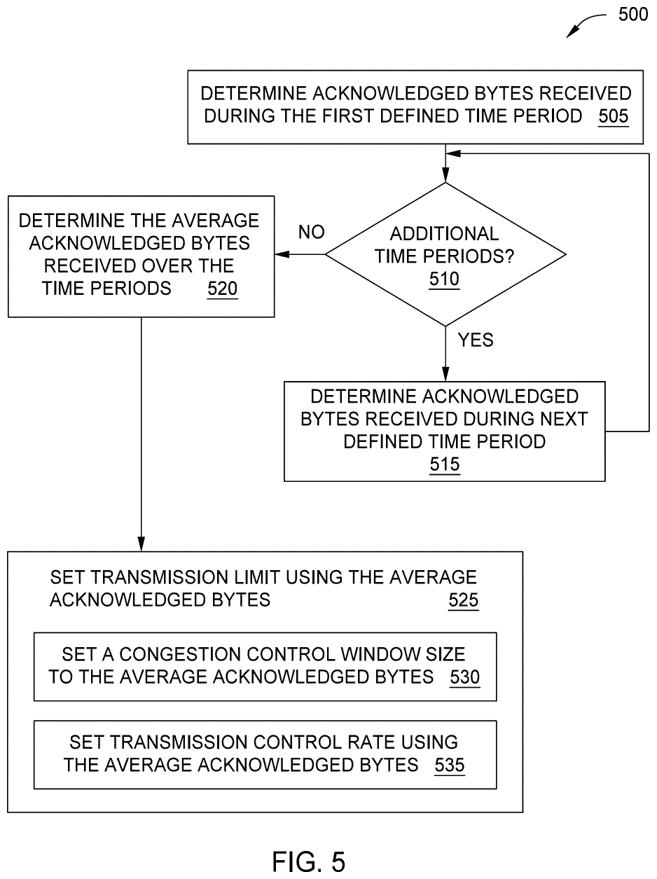

FIG. 5 is a flowchart of a method 500 for averaging acked bytes, according to one embodiment herein. As discussed above in FIG. 3, when the RX queue is congested, the delay is larger than the second threshold and the average delay is larger than the target, the achieved BDP is used to set a transmission limit (e.g., a congestion control window size or a transmission control rate). The achieved BDP can be calculated over one or more previous time periods. The method 500 illustrates one technique for determining an average achieved BDP over multiple time periods.

At block 505, the congestion controller for the sending device determines acked bytes received during a first defined time period. In one embodiment, this time period is the baseline RTT for the connection between the sending and receiving devices. In one embodiment, the time period may not change; however, in other embodiments, the time period used to measure the acked bytes can change.

At block 510, the congestion controller determines whether there are more time periods to consider. For example, the average achieved BDP may be based on averaging the acked bytes in three time periods. The number of time periods considered can be a user controlled parameter.

Assuming there are more time periods to consider, at block 515 the congestion controller determines acked bytes received during the next defined time period. Blocks 510 and 515 can repeat until the congestion controller has determined the acked bytes for the desired number of defined times periods. The congestion controller can accumulate the number of acked bytes that were received during those time periods.

At block 520, the congestion controller determines the average acked bytes received over the time periods. This can include identifying the total acked bytes received and dividing by the number of time periods.

At block 525, the congestion controller sets the transmission limit using the average acked bytes. In one embodiment, at sub-block 520, the congestion controller sets a command window to the average acked bytes (i.e., the average achieved BDP) so that only that amount of data is transmitted to the receiving network device in the next command window. In another embodiment, at sub-block 535, the congestion controller sets rate control using the average acked bytes so that only that amount of data is transmitted to the receiving network device in the next time period. The implementation of sub-block 530 and sub-block 535 may depend on the types of networks and the congestion control techniques used in those networks.

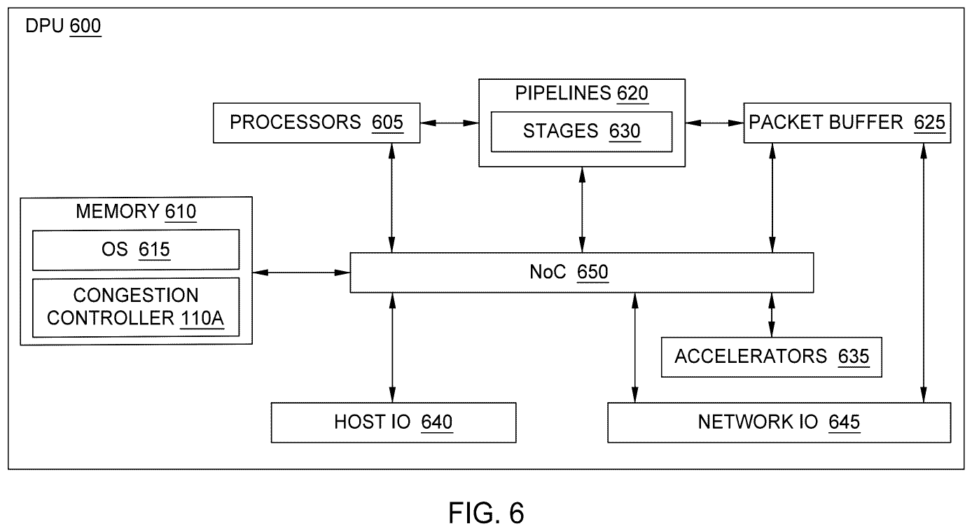

FIG. 6 illustrates a data processing unit (DPU), according to one embodiment herein. In one embodiment, the DPU 600 is a programmable processor designed to efficiently handle data-centric workloads such as data transfer, reduction, security, compression, analytics, and encryption, at scale in data centers. The DPU 600 can improve the efficiency and performance of data centers by offloading workloads from a host central processing unit (CPU) or graphic processing units (GPUs). While CPUs and GPUs can specialize on compute, the DPU may specialize in data movement. The DPU 600 can communicate with host CPUs and GPUs to enhance computing power and the handling of complex data workloads.

The DPU 600 includes a plurality of processors 605. In one embodiment, the processors 605 include any number of processing cores. In one embodiment, the processors 605 may be CPUs. The processors 605 can form one or more CPU core complexes. The processors 605 can be any hardware circuitry that uses an instruction set architecture (ISA) to process data, such as a complex instruction set computer (CISC) or reduced instruction set computer (RISC).

The memory 610 can include volatile or non-volatile memory such as random access memory (RAM), high bandwidth memory (HBM), and the like. The memory 610 can include an operating system (OS) 615 that is separate from the host OS. Moreover, the memory 610 includes the congestion controller 110A to perform the embodiments discussed above. That is, the congestion controller 110A can be implemented in a NIC or a DPU (or could be performed using a host processor).

In one embodiment, the DPU may be in (or be used to implement) a network interface controller/card (NIC) such as a SmartNIC that processes packets before they are forwarded to a host (e.g., a host CPU or GPU). In one embodiment, the DPUs 600 are fully programmable P4 DPUs. The DPU 600 includes multiple pipelines 620 (which can be the same type or different types) for processing received network packets stored in a packet buffer 625. In this example, the pipelines 620 has direct connections to the packet buffer 625.

The pipelines 620 can operate in parallel. Further, the pipelines 620 can be the same type of pipeline (e.g., perform the same tasks). In other embodiments, the DPU 600 may have different types of pipelines 620. For example, the DPU 600 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 620 include multiple stages 630 where received packet data is processed at each stage 630 before being passed to the next stage. This packet data could be the entire packet or just a portion of the packet. For example, a parser in the DPU 600, which is upstream from the pipelines 620, may parse out a particular portion of a received packet (e.g., a packet header vector (PHV)) which is then sent to the one of the pipelines 620.

The stages 630 can include circuitry or hardware. In one embodiment, the stages 630 can be programmed using a pipeline programming language, such as P4. In one example, the stages 630 in one pipeline 620 perform the same functions of the stages 630 in another pipeline 620. However, in other embodiments, the stages may perform different functions.

In addition to the stages, the pipelines 620 may each include memory, which can be referred to as local memory. This memory can store local tables that indicate how, or if, a particular packet should be processed at the stages 630. For example, one of the stages in the pipelines 620 can perform a lookup to read a policing entry in a table to determine whether an entity associated with the packet has exceeded a rate limit (e.g., a packet rate limit, a data rate limit, or both).

The DPU 600 can include accelerators 635 to perform specialized tasks associated with data movement. The accelerators 635 can include a cryptography accelerator, a data compression accelerator, as well as accelerators for performing regex or dedupe.

To communicate with the host and a network, the DPU 600 includes host input/output (IO) 640 and network IO 645. The host IO 640 can include a PCIe interface, or any suitable protocol for communicating with a CPU or GPU in the host. The network IO 645 can include Ethernet interfaces, and the like for communicating with a network.

The DPU 600 includes a network on chip (NoC) 650 for interconnecting the various components discussed above. While a NoC is disclosed, the DPU 600 can include any suitable on-chip network. While some components in the DPU 600 may rely on the NoC 650 to communicate with other components, the DPU 600 can also include connections between components that bypass the NoC 650. For example, the packet buffer 625 can have a connection to the network IO 645 that bypasses the NoC 650. Similarly, the pipelines 620 can exchange packet data with the packet buffer 625 without having to rely on the NoC 650. However, to transfer data to the processors 605, the pipelines 620 may use the NoC 650.

In one embodiment, the DPU 600 includes security and management features such as offering a hardware root of trust, secure boot, and the like.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method, comprising:
transmitting a packet from a sending device to a receiving device;
determining a delay based on receiving an acknowledgement (ACK) from the receiving device; and
upon determining (i) the ACK indicates congestion in a receive (RX) queue when the packet was transmitted from the sending device to the receiving device and (ii) the delay satisfies a second delay threshold that is greater than a target delay threshold, setting a transmission limit used to transmit packets to the receiving device based on an achieved bandwidth delay product (BDP).

2. The method of claim 1, wherein the achieved BDP is a number of acknowledged bytes that is received at the sending device from the receiving device during one or more defined periods of time.

3. The method of claim 2, wherein the one or more defined periods of time is a baseline round trip time (RTT) between the sending device and the receiving device.

4. The method of claim 3, wherein the baseline RTT is based on a RTT value in an uncongested network.

5. The method of claim 2, wherein the achieved BDP is an average number of acknowledged bytes that is received at the sending device from the receiving device during multiple defined periods of time.

6. The method of claim 1, wherein the transmission limit is one of a congestion control window size or a transmission control rate.

7. The method of claim 1, wherein the congestion in the RX queue is indicated by at least one of an explicit congestion notification (ECN) marking or in-network telemetry.

8. The method of claim 7, wherein the ACK indicates that there is congestion in the RX queue when the packet is exiting the RX queue and not whether there is congestion when the packet entered the RX queue.

9. The method of claim 1, wherein setting the transmission based on the achieved BDP is performed upon determining an average delay of multiple packets is greater than the target delay threshold, wherein the second delay threshold is at least 1.5 times greater than the target delay threshold.

10. A sending device comprising:
circuitry configured to:
transmit a packet to a receiving device;
determine a delay based on receiving an ACK from the receiving device; and
upon determining (i) the ACK indicates congestion in a RX queue when the packet was transmitted from the sending device to the receiving device and (ii) the delay satisfies a second delay threshold that is greater than a target delay threshold, set a transmission limit used to transmit packets to the receiving device based on an achieved BDP.

11. The sending device of claim 10, wherein the achieved BDP is a number of acknowledged bytes that is received at the sending device from the receiving device during one or more defined periods of time,
wherein setting the transmission based on the achieved BDP is performed upon determining an average delay of multiple packets is greater than the target delay threshold.

12. The sending device of claim 11, wherein the one or more defined periods of time is a baseline round trip time (RTT) between the sending device and the receiving device, wherein the baseline RTT is based on a RTT value in an uncongested network.

13. The sending device of claim 11, wherein the achieved BDP is an average number of acknowledged bytes that is received at the sending device from the receiving device during multiple defined periods of time.

14. The sending device of claim 10, wherein the transmission limit is one of a congestion control window size or a transmission control rate.

15. The sending device of claim 10, wherein the congestion in the RX queue is indicated by at least one of an explicit congestion notification (ECN) marking or in-network telemetry.

16. The sending device of claim 15, wherein the ACK indicates that there is congestion in the RX queue when the packet is exiting the RX queue and not whether there is congestion when the packet entered the RX queue.

17. A network interface card/controller (NIC) comprising:
circuitry configured to:
transmit a packet from a sending device to a receiving device;
determine a delay based on receiving an acknowledgement (ACK) from the receiving device; and
upon determining (i) the ACK indicates congestion in a receive (RX) queue when the packet was transmitted from the sending device to the receiving device and (ii) the delay satisfies a second delay threshold that is greater than a target delay threshold, set a transmission limit used to transmit packets to the receiving device based on an achieved bandwidth delay product (BDP).

18. The NIC of claim 17, wherein the achieved BDP is a number of acknowledged bytes that is received at the sending device from the receiving device during one or more defined periods of time,
wherein setting the transmission based on the achieved BDP is performed upon determining an average delay of multiple packets is greater than the target delay threshold.

19. The NIC of claim 18, wherein the achieved BDP is an average number of acknowledged bytes that is received at the sending device from the receiving device during multiple defined periods of time.

20. The NIC of claim 17, wherein one of:
the circuitry is configured to determine the delay based on a RTT delay determined using timestamps associated with transmitting the packet and receiving the ACK, or
the receiving device is configured to transmit a one-way delay to the sending device using the ACK.
